(19) United States
(12) Patent Application Publication
(10) Pub. No.: US 2012/0318442 A1
(43) Pub. Date: Dec. 20, 2012

(54) Process for the Manufacture of a Leaktight Bladder of a Type IV Tank, and Type IV Tank

(76) Inventors: Philippe MAZABRAUD, Orleans (FR); Gwénaël DOULIN, La Chapelle sur Erdre (FR); Katia BARRAL, Le Chesnay (FR)

(21) Appl. No.: 13/592,724

(22) Filed: Aug. 23, 2012

Related U.S. Application Data
(62) Division of application No. 11/628,140, filed on Nov. 29, 2006, now abandoned.

(30) Foreign Application Priority Data
Jun. 3, 2004 (FR) 0451104

(51) Int. Cl. B29C 70/86; B29C 45/14

(52) U.S. Cl. 156/172; 264/279

(57) ABSTRACT

The present invention relates to a process for the manufacture of a bladder (2) of thermoplastic polymer for leaktightness to the gases of a type IV composite tank (1) and to a type IV tank (1) capable of being obtained by this process. The process of the invention comprises a stage of polymerization of a precursor monomer of said thermoplastic polymer to give said thermoplastic polymer in a rotating mold heated to a working temperature greater than or equal to the melting point of said monomer and lower than the melting point of said polymer, so as to form said bladder (2) by polymerization of said monomer coupled to rotomolding and without melting of the thermoplastic polymer obtained.

This application is a Divisional of U.S. patent application Ser. No. 11/628,140, filed Nov. 29, 2006, the entire contents of which are hereby incorporated by reference. U.S. patent application Ser. No. 11/628,140 is National Stage application of International Application No. PCT/FR2005/050403, filed Jun. 1, 2005, the entire contents of which are hereby incorporated by reference. U.S. patent application Ser. No. 11/628,140 also claims priority under 35 U.S.C. §119 to FR Patent Application No. 0451104, filed Jun. 3, 2004, the entire contents of which are incorporated herein by reference.

### TECHNICAL FIELD

The present invention relates to a process for the manufacture of a thermoplastic polymer bladder for leaktightness to gases of a type IV composite tank and to a type IV tank capable of being obtained by this process.

The field targeted is the storage of gas under pressure (pressure greater than atmospheric pressure) with a particular interest in natural gas and especially in hydrogen.

Type IV composite tanks are tanks in which the pressure of the stored gases is generally from 10⁶ to 10⁸ Pa. Their structure must therefore be planned, on the one hand, to be leaktight to the gases stored, and, on the other hand, to withstand the storage pressures of these gases. This is why these tanks comprise an internal bladder for leaktightness to gas, also referred to as internal liner, and an external reinforcing structure usually composed of carbon fibers and of thermosetting resin.

The leaktight bladder is a structure of revolution, generally without welding and homogeneous, exhibiting improved properties of permeability to gas and of mechanical strength. It is obtained by rotomolding. The external reinforcing structure can be obtained, for example, by filament winding.

The major application targeted by the present invention is the low temperature fuel cell (PEMFC).

In the description below, the references between brackets ([ ]) refer to the list of the references presented in the examples.

### PRIOR ART

Type IV tanks were developed in the 1990s, first for the storage of natural gas with polyethylene bladders and more recently, essentially from 1997, for the storage of hydrogen.

The thermoplastic bladders currently used are very largely composed of polyethylenes (PE) which are generally of high density (HDPE) and sometimes crosslinked (XHDPE). Other thermoplastics of polyamide (PA) type (generally referred to as “Nylon” (trade mark)), of PA6, PA12 or PA11 type, are also used as they exhibit better intrinsic barrier properties to gases than polyethylene. Finally, other types of more practical thermoplastics can be used because they exhibit good barrier properties to gases, such as poly(vinylidene difluoride) (PVDF) or multilayer solutions with a barrier layer made of ethylene/vinyl alcohol (EVOH) copolymer. The documents [1] and [2] disclose such thermoplastics.

Most of the time, these bladders are obtained by rotomolding or extrusion and/or blow molding of the molten thermoplastic. Thus, in the document [3], mention is made that the thermoplastic bladder is obtained by extrusion-blow molding or rotomolding, preferably using a high or medium density polyethylene. In the document [4], leaktight bladders made of polyethylene, polypropylene or polyamide are obtained by rotomolding. In the document [5], it is specified that the bladder made of nylon 11 is produced by rotomolding. In the document [6], mention is made that the bladder is obtained from a thermoplastic which is extruded, blow-molded or rotomolded. In the documents [7] and [8], mention is made that the thermoplastic bladder can be molded by extrusion, blow molding or rotomolding.

Injection molding is rarely used for technical limitations and questions of cost of press and of mold. This is because the leaktight bladders can have up to 150 liters of internal volume with thicknesses of several centimeters. Thermoforming is rarely used, although it is technically possible to use this technology to produce such leaktight bladders.

The current technology for the rotomolding of molten thermoplastics is of particular interest. This is because it makes it possible:
to be able to manufacture large-size components ranging up to 150 liters, indeed even beyond;
to be able to insert one or more socket(s) (connecting pipe which makes it possible to fill the bladder with gas and to empty it), this being the situation without adhesive bondings during the processing; and
to provide thick and homogeneous leaktight bladders.

The web site [9] of the Association Française de Rotomoulage [French Rotomolding Association] (AFR) describes a protocol for rotomolding by melting a thermoplastic.

In all these processes, the thermoplastic is melted in order to be shaped to the geometry of the desired bladder and then has to be cooled before being removed from the mold. Numerous defects in the bladder result from this melting, in particular the formation of crosslinked material, of unmelted material or of microporosities and the occurrence of oxidation of the thermoplastic. These defects are harmful to the final leaktight performance of the bladder and thus to the performance of the tank. Furthermore, in the case of the rotomolding, even if adhesive bonding of the socket to the bladder is not necessary, the leaktightness between the socket and the bladder is not always satisfactory due to the plasticity of the molten thermoplastic, which is insufficient to closely match the forms of the socket. Furthermore, this plasticity of the molten thermoplastic cannot be increased by raising the temperature without bringing about a detrimental chemical change in said thermoplastic. In addition, the processes used take a long time, further extended by the cooling time of the thermoplastic after molding the bladder, due in particular to the inertia of the mold.

Polyamide 6 (PA6) is the thermoplastic apparently the most advantageous in the manufacture of leaktight bladders due to the compromise between its barrier properties to gases, in particular hydrogen, and its mechanical properties over a wide temperature range extending from −40° C. to +100° C. Unfortunately, in the techniques of the prior art, PA6 is still poorly suited to rotomolding, which, like the other technologies for molding thermoplastics, requires melting the thermoplastic in the powder form in order to give it the desired shape and then cooling it. This melting produces the defects identified above, which are harmful to the final performance of the tank. The development of thermoplastics, for example PA6, with grades at most suited to rotomolding, that is to say having a water content of the powders, a viscosity, a molecular weight, antioxidants, and the like, does not make it possible to annul these defects. Furthermore, the development of the technology of rotomolders, for example rotomolding under nitrogen, controlled cooling, reduction in the cycle time, does not make it possible either to annul these defects. This is because, for example, as the melting of PA6 begins from 200° C. approximately, this melting stage causes chemical decomposition as the molten PA6 has to remain above its melting point for 5 to 15 minutes with processing temperatures exceeding the melting point by sometimes 40° C.

The documents [10] to [15] show the current state of the art, the developments under way, and in particular what are the thermoplastics and their processing for the development of type IV tanks for fuel cell application.

No technique of the prior art provides a satisfactory solution to the numerous abovementioned problems.

There thus exists a real need for a process which overcomes these defects, disadvantages and obstacles of the prior art, in particular for a faster and cheaper process which makes it possible to obtain a leaktight bladder for a type IV tank not exhibiting the abovementioned defects.

This process should in particular make possible the manufacture of a bladder for a low temperature fuel cell (PEMFC) for which the storage of the hydrogen, carried out under pressures ranging from 350×10⁵ Pa to 700×10⁵ Pa, indeed even 1000×10⁵ Pa, requires light, safe and inexpensive tanks, in particular for storage on moving vehicles (transportations).

### Account of the Invention

An aim of the present invention is specifically to solve the abovementioned problems of the prior art by providing a process for the manufacture of a thermoplastic polymer bladder for leaktightness to gases of a type IV composite tank, said process comprising a stage of polymerization of a precursor monomer of said thermoplastic polymer to give said thermoplastic polymer in a rotating mold, also referred to as rotomold, heated to a working temperature greater than or equal to the melting point of said monomer and lower than the melting point of said polymer, so as to form said bladder by polymerization of said monomer coupled to rotomolding and without melting of the thermoplastic polymer obtained.

The invention also relates to a process for the manufacture of a bladder for leaktightness to gases of a type IV composite tank, said bladder being composed of a thermoplastic polymer, said process comprising the following stages:

(a) preparation of a polymerization mixture comprising the precursor monomer of the thermoplastic polymer, a polymerization catalyst and a polymerization activator;

(b) polymerization of said mixture to give said thermoplastic polymer in a rotating mold heated to a working temperature greater than or equal to the melting point of said monomer and lower than the melting point of said polymer, so as to form said bladder by polymerization of said monomer coupled to rotomolding and without melting of the thermoplastic polymer obtained;

(b1) optionally repetition of stages (a) and (b), so as to obtain a bladder comprising several layers of thermoplastic polymer; and

(c) removal from the mold of the thermoplastic polymer bladder obtained.

In the present invention, the polymer is manufactured and molded in a single step in a mold and at a temperature below its melting point. The process of the present invention does not start either from the molten thermoplastic polymer, as in the prior art, but from its monomers, which are polymerized in the rotating mold at a temperature lower than the melting point of the polymer obtained. The polymer is then formed at the same time as it matches the form of the mold. It is then possible to speak of “reactive rotomolding” since the rotomolding mold acts both as chemical reactor and as mold giving the shape of the bladder proper.

The reaction for the polymerization of the monomer used in the present invention is an entirely conventional chemical reaction which makes it possible to polymerize a precursor monomer of a thermoplastic polymer to give said thermoplastic polymer. A person skilled in the art who is an expert in organic chemistry will have no difficulty in carrying out this polymerization reaction. The only restrictions are those indicated in the definition of the process of the invention, that is to say those related to the specific features of the thermoplastic bladders of the type IV gas tanks. In particular, it is preferable for the bladder obtained to be impermeable to the gas which will be stored therein, even at the pressures indicated above.

This is why, according to the invention, the precursor monomer of the thermoplastic polymer used is preferably a precursor monomer of one of the thermoplastic polymers used for the manufacture of such bladders.

According to the invention, preferably, the thermoplastic polymer is a polycaprolactam and the monomer its precursor, the polymerization of the monomer being an anionic polymerization. In this case, for example, the monomer can be a caprolactam or an ε-caprolactam or a mixture of these.

According to the invention, the polymerization of the monomer is preferably carried out in the presence of an activator and/or of a catalyst. Their role in the polymerization of an organic monomer is well known to a person skilled in the art and does not require being specified further here. Mention may be made, as example, of the anionic polymerization of poly(α-methylstyrene) (PAM) from the α-methylstyrene monomer, from the activator of the family of the organolithium derivatives (for example, a diphenylalkyllithium) and from the catalyst crown ether. Mention may also be made, as example, of the anionic polymerization of polystyrene (PS) from the styrene monomer, from the activator of the family of the organolithium derivatives and from the catalyst tetrahydrofuran (THF).

For example, when the monomer is a caprolactam, the activator can advantageously be a first substituted ε-caprolactam, for example an acylcaprolactam. For example, when the monomer is a caprolactam, the catalyst can advantageously be a second substituted ε-caprolactam, for example a sodium lactamate or a bromomagnesium lactamate. Other activators and catalysts having an equivalent role in the polymerization reaction concerned can naturally be used. The documents [16] and [17] describe a number of activators and catalysts which can be used for the implementation of the present invention.

According to the invention, the stage consisting in polymerizing the monomer in the rotomold in order to form the bladder made of thermoplastic polymer is advantageously carried out starting from a polymerization mixture comprising the precursor monomer of the thermoplastic polymer, a polymerization catalyst and a polymerization activator.

According to the invention, the polymerization mixture can advantageously be prepared by mixing a first mixture, comprising said monomer and said catalyst, and a second mixture, comprising said monomer and said activator. Thus, the two mixtures can be prepared and stored separately several weeks, indeed even several months, before the manufacture of the bladder and mixed together at the time of the implementation of the present invention.

The process of the present invention can also be carried out starting from a single mixture comprising the monomer and the catalyst, the polymerization activator being added at the time of the implementation of the process of the present invention. The mixture can also be entirely prepared at the time of use, before being introduced into the mold. A person skilled in the art will know how to easily adjust the implementation of the process of the present invention according to what appears to him the most practical.

Examples of the preparation of the polymerization mixture are presented below.

The metering of the monomer used can be carried out in the solid state, for example, for caprolactam, at ambient temperature and up to approximately 70° C., or in the liquid state, for example, for caprolactam, at a temperature above 70° C. It is the same for the catalyst and the activator, and for any other material added to the polymerization mixture.

According to the invention, the polymerization mixture can furthermore comprise a nucleating agent and/or fillers and/or nanofillers. These agents and fillers can participate in particular in the gas-barrier and strength properties of the bladder.

Thus, the nucleating agents advantageously make it possible to increase the crystallinity and a fortiori the barrier properties of the thermoplastic material, for example of polyamide 6. According to the invention, the nucleating agent can be chosen, for example, from the group consisting of talcs and sodium benzoates or any other agent having the same role, or a mixture of these. Whatever the nucleating agent, it can be added to the polymerization mixture in an amount ranging from 0 to 20% by weight, with respect to the total weight of the polymerization mixture introduced into the mold, generally from 0.01 to 1% by weight.

The fillers or nanofillers (depending on the size and/or on the aspect ratio of the particles of which they are composed) advantageously make it possible to increase the stiffness and/or to improve the thermomechanical properties and/or to reduce the permeation and/or to color and/or to reduce the cost of the bladder manufactured. According to the invention, the fillers and/or nanofillers can be chosen, for example, from the group consisting of clay sheets, carbon black, silicas, carbonates, pigments or any other filler or nanofiller having the same role. For example, exfoliated clay sheets make it possible to improve the thermalstability of the bladder, in particular to the heating during the rapid filling of the bladder with gas, for example with hydrogen. Whatever the filler or nanofiller, it can be added to the polymerization mixture in an amount ranging from 0 to 40% by weight, with respect to the total weight of the polymerization mixture introduced into the mold, generally from 1 to 20% by weight.

The amount of polymerization mixture introduced into the mold determines, depending on the size of the mold, the thickness of the wall of the bladder manufactured according to the process of the present invention.

The choice of this thickness of the wall of the bladder is made mainly:
according to the desired performance of barrier to the stored gas, for example to hydrogen, of the thermoplastic (for hydrogen, draft standards ISO TC 197 and EIHP II, which allow an escape of 1 cm³/liter of tank/hour), and
according to the mechanical performance of the thermoplastic, in particular of mechanical resistance to the deploying of a mechanical reinforcing member external to the bladder, for example by winding on carbon fibers (the bladder then acting as winding tube), during the manufacture of the tank.

The three mathematical equations which can be related to for the determination of the thickness of the wall of the bladder manufactured (the “dimensioning”) are as follows:

$$\begin{matrix}{Pe}_{me} = \frac{Gf \cdot t}{Δ P \cdot S} in mol / ( m \cdot Pa \cdot s ) where \\ \{ \begin{matrix}Gf = gas flow ( mol \text{/} s ) \\ t = thickness of the wall ( m ) \\ Δ P = pressure difference ( Pa ) \\ S = Surface area of the wall ( {m}^{2} )\end{matrix} & ( I ) \\ {σ}_{ra d} = \frac{L / D \cdot P \cdot {( \frac{4 V}{π \cdot L / D} )}^{\frac{2}{3}}}{t \cdot ( ( L / D + 1 ) \cdot {( \frac{4 V}{π \cdot L / D} )}^{\frac{1}{3}} + 2 t )} where \\ \{ \begin{matrix}{σ}_{r ad} = radical stress in Pa \\ L = length of the tank in m \\ D = diameter of the tank in m \\ t = thickness of the tank in m \\ V = volume of the tank in {m}^{3} \\ P = working pressure of the tank in Pa\end{matrix} & ( II ) \\ {σ}_{axi} = \frac{2 P \cdot {( \frac{4 V}{π \cdot L / D} )}^{\frac{2}{3}}}{( {( \frac{4 V}{π \cdot L / D} )}^{\frac{1}{3}} + 2 t ) {( \frac{4 V}{π \cdot L / D} )}^{\frac{2}{3}}} where \\ \{ \begin{matrix}{σ}_{axi} = axial stress in Pa \\ L = length of the tank in m \\ D = diameter of the tank in m \\ t = thickness of the tank in m \\ V = volume of the tank in {m}^{3} \\ P = working pressure of the tank in Pa\end{matrix} & ( III )\end{matrix}$$

Described and explained in the documents [18], [19] and [20].

The determination of the thickness of the wall of the bladder is thus decided in particular according to the volume of the tank manufactured, the Length/Diameter ratio of the tank (and thus the surface area developed), the acceptable mechanical stresses and the working pressure of the tank manufactured.

According to the invention, the bladder generally has a wall thickness defined in order to withstand the escape of the gas at the pressure at which it has to be stored, referred to as working pressure, usually between 2×10⁷ and 7×10⁷ Pa. The present invention applies, of course, to other pressures than these, the thickness of the bladder being chosen in particular according to this working pressure and the nature of the gas. Generally, the thickness of the bladder is between 1 mm and 20 mm, preferably between 2 mm and 10 mm.

In the process of the invention, the polymerization is carried out in a rotating mold. For this, use may be made of a conventional rotomolder, for example such as those described in the abovementioned documents relating to the rotomolding of a molten thermoplastic. Preferably, the mold of the rotomolder is sufficiently impermeable to liquids, in particular to the polymerization mixture according to the invention.

According to the invention, the polymerization is carried out at a temperature, referred to as working temperature, which is greater than or equal to the melting point of said monomer and lower than the melting point of said polymer, so as to form said bladder by polymerization of said monomer coupled to rotomolding and without melting of the thermoplastic polymer obtained. Thus, the mold being set rotating, the polymerization results in the formation of the thermoplastic over the entire internal surface of the mold, without the occurrence of melting of said thermoplastic. A melting-free rotomolding is thus involved. When the melting point of the polymer is reached or exceeded during the polymerization of the monomer, this results in the abovementioned defects of the bladders of the prior art obtained by rotomolding the molten thermoplastic.

According to the invention, when the monomer used is in the solid form, the polymerization mixture can be preheated in order to melt the monomer before polymerizing it in the rotating mold. For example, according to the invention, in stage (a), the polymerization mixture can furthermore be preheated, so as to melt the monomer, to a preheating temperature greater than or equal to the melting point of said monomer and lower than the melting point of said polymer. A person skilled in the art will easily know how to determine the melting point of the monomer, for example using a melting point bench. The melting point of the thermoplastic polymer obtained can also be easily determined by the person skilled in the art, for example also using a melting point bench.

For example, when the monomer is a caprolactam, according to the invention, the reaction for its polymerization to give polycaprolactam is carried out at a temperature of between 70° C. and 220° C., preferably between 100 and 180° C., and thus below the melting point of PA6 and thus far below its rotomolding temperature of the prior art.

According to the invention, advantageously, the polymerization mixture can be heated to said working temperature before being introduced into the mold. Thus, the polymerization can be triggered from the introduction of the mixture into the rotomold.

For the same reasons, according to the invention, preferably, the rotomold is preferably heated to said working temperature before introduction of said polymerization mixture into the mold.

The mold can be heated, for example, using an oven into which the mold is introduced. It is optionally possible to manage without an oven by using a mold with integral heating (heating device incorporated in the mold), for example heating by infrared (IR) lamps, electrical resistances or a jacketed mold with circulation of a feed-transfer fluid.

It is in some cases possible not to use an oven during the polymerization itself, in view of the thermal inertia of the mold and of the speed of the polymerization reaction, in particular when this polymerization is of anionic type.

The mold can advantageously be equipped with a vent and with an inlet for neutral gas when the polymerization reaction carried out has to be carried out under a neutral (inert) gas. In this case, the mold is then purged by an inert gas for the implementation of the polymerization stage. This is the case, for example, when the monomer is a caprolactam. The neutral gas can, for example, be nitrogen or any other neutral gas known to a person skilled in the art. In the example of the caprolactams, the neutral gas is very preferably dry, in order for the polymerization reaction to take place in an anhydrous medium. This is because the best polymerization and leaktightness results were obtained under these operating conditions for the caprolactams, for example in order to obtain bladders made of PA6. This can be the case for other monomers. A person skilled in the art will easily know how to adapt the implementation of the process of the invention in order for the polymerization of the monomer to result in the manufacture of the desired bladder.

According to the invention, the mold is set rotating along two axes, so that the polymerization takes place over the entire internal surface of the mold and in accordance with the internal surface. This twofold rotation can be provided on a conventional rotomold.

On rotomolding molten material according to the prior art, the rotational speeds of the primary axis and of the secondary axis are between 1 and 20 rpm (revolutions per minute), generally between 2 and 10 rpm. In the process of the present invention, the rotational speeds are preferably higher, as a result of the plasticity of the monomer, which is greater than that of the molten material. Thus, according to the invention, the rotational speed of the mold is preferably from 5 to 40 rpm, more preferably from 10 to 20 rpm. These preferred rotational speeds have given very good results in the case of caprolactams.

The polymerization time depends, of course, on the monomer used and on the presence and on the nature of the catalysts and/or activators. One of the many advantages of the present invention is that the polymerization reactions can be very rapid. For example, when the monomer used is a caprolactam, an anionic polymerization to give PA6 is complete after a few minutes, generally from 2 to 10 minutes, often around 4 minutes.

When the polymerization is complete, in particular when the length of the chains is satisfactory and the crystallization accomplished (organization of the polymer chains), if appropriate the heating is halted or the rotating mold is removed from the oven; the rotation of the mold is halted and the mold is opened. The mold can be cooled for a few minutes, in particular in order to facilitate rehandling of the component, in order to avoid any risk of burns. The bladder is then removed from the mold. The result of this is an obvious saving in time in comparison with the processes of the prior art, in particular in view of the inertia of the mold, where the melt rotomolding temperature was much greater than that used in the process of the present invention and where it was necessary to wait for the material to change from the molten state to the solid state.

According to a specific embodiment of the present invention, several polymerization stages can be carried out successively to form a leaktight bladder comprising several layers of thermoplastic polymer. These layers can be identical or different, in thickness or in composition.

For example, in order to obtain wall thicknesses for bladders of greater than 3 to 4 mm, advantageously, several successive polymerization stages will be carried out until the desired thickness is reached. According to the invention, these polymerization stages can use a precursor monomer of the thermoplastic polymer which is identical or different from one stage to another. It is sufficient to successively introduce the polymerization mixture or mixtures into the mold, after each polymerization stage is complete. For example, with an anionic polymerization, it is easy to prepare 5 mm per layer but a thickness of 3 mm is preferable. Thus, for a bladder wall thickness of 6 mm, it is preferable to prepare two successive layers of the thermoplastic material.

For example, when the innermost layer of the bladder, that is to say that which will be in contact with the pressurized gas during its storage in the type IV tank manufactured, has to have specific properties with respect to said stored gas, the final polymerization stage can advantageously be carried out using a thermoplastic polymer exhibiting said specific properties with respect to said stored gas. For example, it may be an internal layer made of PA6 comprising nanofillers of montmorillonite type in order to increase the thermomechanical strength of the liner during the rapid filling of the tank.

For example, when the outermost layer of the bladder, that is to say that which would be in contact with the external reinforcing structure of the type IV tank manufactured, has to have specific properties with respect to said reinforcing structure, the final polymerization stage can advantageously be carried out using a thermoplastic polymer exhibiting these specific properties with respect to said reinforcing structure. For example, it may be an external layer made of PA6 without nucleating agent in order to increase the impact strength of the liner before carrying out the winding on of the composite (handling operations).

According to the invention, the bladder obtained can furthermore be subjected to one or more posttreatment(s) intended to coat its internal or external surface with one or more thin layer(s) in order to further improve the properties of leaktightness of the bladder to the gas which will be stored therein (barrier properties) and/or to confer on it specific chemical properties, for example of resistance to chemical attacks, a food grade quality or better resistance to aging. This posttreatment can consist of a treatment for a deposit of SiOx type, where 0≦x≦2, or else Si_{y}N_{z}Cₜ type, where 1≦y≦3, 0.2≦z≦4 and 0≦t≦3, by plasma-enhanced vapor phase deposition (PECVD), of aluminum by physical vapor deposition (PVD), for a deposit of epoxy type by chemical crosslinking, or fluorination with CF₄, for example. The documents [21] and [22] describe this type of posttreatment well known to a person skilled in the art in the manufacture of type IV tank bladders which can be used on the bladder obtained by the process of the present invention.

The present invention thus makes possible the manufacture of thermoplastic leaktight bladders, including of polyamide type, and advantageously of polyamide 6 type (optionally modified and/or comprising a filler), capable of participating in the manufacture of any composite tank intended for the storage of gas, in particular of pressurized gas. The leaktight bladders manufactured by the process of the invention are more effective in terms of mechanical and gas-barrier properties than those of the prior art as there are no longer effects of cleavage of chains, of oxidation, of crosslinking, of polycondensation, of final porosity, of residual stresses or nonhomogeneity, and the like, inherent in the phenomena of melting and of solidification of thermoplastic polymers. In addition, the internal surface condition of these bladders is much better than that of bladders obtained by a molten thermoplastic process of the prior art. These improved properties obviously very much affect the properties of the tanks which are manufactured from these bladders.

The invention thus also relates to a composite tank for storage of a pressurized gas, said tank comprising a thermoplastic polymer bladder for leaktightness to said pressurized gas obtained according to the process of the invention.

For example, the present invention makes it possible to obtain a tank comprising, in this order, from the inside of the tank outwards:
said bladder for leaktightness to the pressurized gas,
at least one metal socket, and
a member for mechanically reinforcing the bladder.

This type of tank is referred to as type IV tank. The thermoplastic bladder manufactured according to the process of the invention makes it possible to obtain a type IV composite tank, the mechanical and barrier performances of which are much better than those of the same tank but where the bladder (composed of the same thermoplastic) is manufactured by extrusion-blow molding, thermoforming, injection molding or rotomolding of the molten thermoplastic.

According to the invention, the leaktight bladder is preferably a polyamide bladder. Advantageously, the polyamide bladder is a polycaprolactam bladder. This is because the best current results for implementation of the present invention are obtained with this polymer.

According to the invention, said at least one metal socket provides the internal/external connection of the tank for the filling thereof and for the use of the stored gas. The socket can be a socket conventionally used for this type of tank, for example an aluminum socket. One or more socket(s) can be positioned in the mold in order to obtain one or more sockets on the bladder manufactured. The socket(s) can be subjected to a treatment intended to further improve the leaktightness of the socket/bladder junction, for example a treatment such as that disclosed in the document [4].

The inclusion of one or more socket(s) on the bladder can be carried out according to the conventional processes known to a person skilled in the art, for example according to the processes disclosed in the documents [4] and [23] or in one of the abovementioned documents where at least one socket is provided. However, in the present invention, the thermoplastic polymer is not melted in order to be joined to the socket; it is formed by polymerization of the monomer both in the mold and over the socket or sockets positioned in the mold before the rotomolding according to the process of the present invention. The socket(s) can be positioned, for example, in the way disclosed in the document [23]. The bladder obtained according to the process of the invention, equipped with the socket(s), is subsequently removed from the mold.

By virtue of the process of the present invention, the risk of leakage at the sockets is greatly reduced as, during the rotomolding, the viscosity of the monomer at the beginning of polymerization is very low and the monomer very readily diffuses into the chinks and/or points of attachment of the socket.

According to the invention, the external member for mechanically reinforcing of the bladder provides for the mechanical strength of the tank. It can be any one of the reinforcing members known to a person skilled in the art habitually positioned around the bladders of type IV tanks. It can be, for example, a filament winding. This filament winding can be composed, for example, of carbon fibers and of thermosetting resin. For example, the carbon fiber, impregnated beforehand with noncrosslinked epoxy resin, can be wound around the bladder held by the socket or sockets, for example according to one of the processes disclosed in the documents [4], [5], [24] or [25]. The bladder, which is a self-supported structure, in fact acts as winding tube for this filament winding. A type IV tank is thus obtained.

The present invention finds an application in the storage of any pressurized gas, for example of hydrogen gas, of helium, of natural gas, of compressed air, of nitrogen, of argon, of Hytane (trade name), and the like. The present invention is particularly suitable for the manufacture of fuel cells, in particular low temperature fuel cells, for which the mechanical requirements are very strict, and high temperature fuel cells, for which the leaktightness requirements are very strict.

Other characteristics and advantages will become more apparent to a person skilled in the art on reading the examples which follow, given by way of illustration and without implied limitation, with reference to the appended figures.

### BRIEF DESCRIPTION OF THE FIGURES

FIG. 1 diagrammatically represents an example of the structure of a type IV tank (1) manufactured from a bladder (2) in accordance with the present invention. This figure represents the functionalities of the various components of which this tank is composed.

FIG. 2 is a graph exhibiting curves of temperature (T) in ° C. as a function of the time (t) in minutes: of the oven (curve 10), of the rotomold (curve 12) and of the atmosphere in the rotomold (curve 14) during the implementation of a process for the rotomolding of PA6 of the prior art, that is to say by melting the thermoplastic (example 2 below).

FIG. 3 is a graph exhibiting curves of temperature (T) in ° C. as a function of the time (t) in minutes: of the oven (curve 20), of the rotomold (curve 22) and of the atmosphere in the rotomold (curve 24) during the implementation of a process for the rotomolding of PA6 according to the present invention, that is to say at a temperature lower than the melting point of the thermoplastic (example 2 below).

FIG. 4 is a graph exhibiting the curves of temperature (T) in ° C. as a function of the time (t) in minutes: of the oven (curve 30) and of the gas in the rotomold (curve 32) during the implementation of a process for the rotomolding of PA6 according to the present invention, that is to say at a temperature lower than the melting point of the thermoplastic (example 3 below).

FIGS. 5A, 5B, 5C, 5D and 5E diagrammatically exhibit various methods of preparation of polymerization mixtures which can be used for the implementation of the process of the present invention.

### EXAMPLES

### Example 1

### Manufacture of a Tank Bladder by a Rotomolding Process of the Prior Art: Rotomolding of PA 6 by the Molten Route

The thermoplastic used in this example is polyamide 6 (or polycaprolactam). The supplier is Rhodia Engineering Plastics (France). The commercial grade is Technyl C217 (trade name).

The rotomolding protocol which was employed in this example is as follows:
Heating of the oven to a temperature of 350° C.;
Amount of thermoplastic: 400 g;
Preheating of the mold to 55° C.;
Cooking: 15 min;
Cooling after rotomolding: 30 min;
Rotation of speeds of the mold along at least two axes: primary rotation: 2 rpm, and secondary rotation: 1.5 rpm;
Rotomolding carried out under nitrogen;
Rotomolder: Shuttle type from STP Equipment with the reference LAB40.

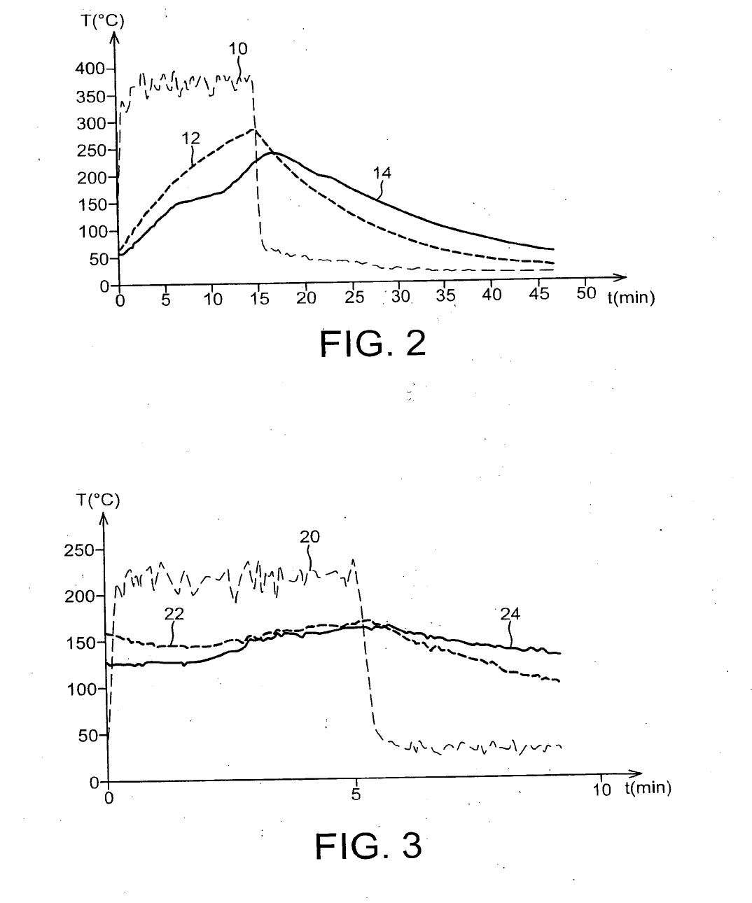

The appended FIG. 2 is a graph exhibiting the curves of temperature (T) in ° C. as a function of the time (t) in minutes: of the oven (curve 10), of the rotomold (curve 12) and of the atmosphere in the rotomold (curve 14) during the implementation of this protocol.

The main properties of the polymer material forming the bladder are as follows:
density: 1.14 g/cm³
molar mass: between 20 and 40 kg/mol
melting point: 222° C.
modulus of elasticity: 2.9 GPa (EH 0-23° C.)
yield point stress: 85 MPa (EH 0-23° C.)
deformation at break: 100% (EH 0-23° C.)
hydrogen permeation (4×10⁵ Pa, 27° C.): 5.4×10⁻¹⁶ mol/m·Pa·s
rough internal surface condition.

### Example 2

### Manufacture of a Tank Bladder by a Rotomolding Process of the Present Invention: Reactive Rotomolding of PA6

The polymerization is an anionic polymerization. The precursor monomer is ε-capro-lactam. The supplier is Fluka. It has a purity of greater than 98% and a melting point of 69° C. The thermoplastic polymer obtained is polyamide 6 (or polycaprolactam).

Sodium caprolactam (17%) in caprolactam was used as polymerization catalyst. This catalyst is supplied, for example, by Brüggemann Chemical. Commercial grade: Bruggolen C10 (registered trade mark); form: flakes; melting point: approximately 60° C.

Block diisocyanate (17%) in caprolactam was used as polymerization activator. This activator is supplied, for example, by Brüggemann Chemical. Commercial grade: Bruggolen C20 (registered trade mark); form: powder; melting point: greater than 60° C.

The chemical equation of the anionic polymerization reaction carried out in this example is as follows:

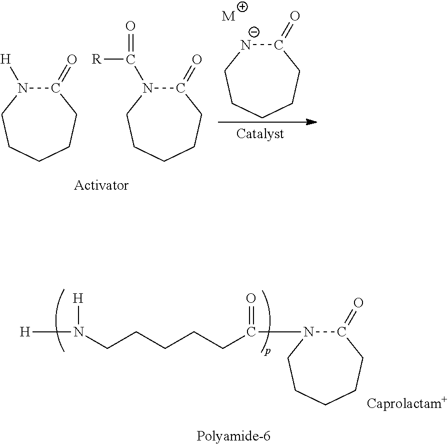

in which p is the degree of polymerization. This degree of polymerization is generally such that 1≦p≦100 000.

Two polymerization mixtures were used:
The first contained caprolactam (monomer solid at ambient temperature) and catalyst (solid at ambient temperature).
The second contained caprolactam (monomer solid at ambient temperature) and activator (liquid at ambient temperature).

The two mixtures were brought to a temperature of greater than 70° C. (all the components are then liquid) in order to homogenize them and to subsequently introduce them into the mold of the rotomolder.

The protocol is also valid for a single mixture comprising the combination of the caprolactam and the catalyst. After having heated it to at least 70° C., this liquid mixture is introduced into the mold and then all of the liquid activator is injected into the mold.

The rotomolding protocol which was employed in this example is as follows:
Preparation of a first mixture of 188 g of ε-caprolactam, Fluka (trade name), and of 12 g of catalyst, Bruggolen C10 (registered trade mark);
Preparation of a second mixture of 188 g of ε-caprolactam, Fluka (trade name), and of 12 g of activator, Bruggolen C20 (registered trade mark);
Preheating of the two mixtures to 130° C.;
Heating of the oven to a temperature of 220° C.;
Preheating of the rotomold to 160° C.;
Addition of the first mixture to the second mixture and introduction into the preheated mold;
Rotational speeds of the mold along at least two axes: primary rotation: 10 rpm, and secondary rotation: 5.2 rpm;
Rotomolding carried out under dry nitrogen;
Machine: Shuttle type from STP Equipment with the reference LAB40;
Total amount of material used (monomer+catalyst+activator): 400 g;
Polymerization time: 5 min;
Cooling time: 10 min.

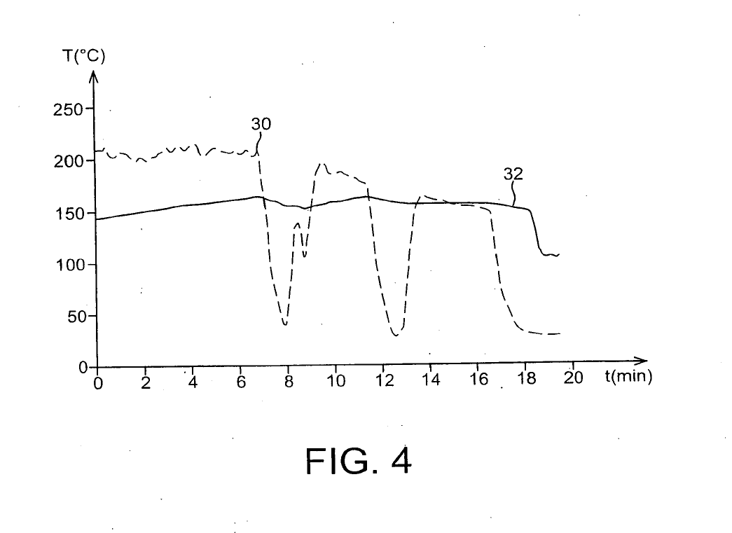

FIG. 3 is a graph exhibiting the curves of temperature (T) in ° C. as a function of the time (t) in minutes: of the oven (curve 20), of the rotomold (curve 22) and of the atmosphere in the rotomold (curve 24) during the implementation of this protocol.

A thermoplastic bladder formed of polyamide 6 is obtained. The main properties of the polymer are as follows:
density: 1.15 g/cm³;
molar mass: 50-300 kg/mol;
melting point: 225° C.;
modulus of elasticity: 3.6 GPa (EH 0-23° C.);
yield point stress: 90 MPa (EH 0-23° C.);
deformation at break: 70% (EH 0-23° C.);
hydrogen permeation (4×10⁵ Pa, 27° C.): 3.7×10⁻¹⁷ mol/m·Pa·s;
perfectly smooth internal surface condition.

In comparison with the bladder obtained in example 1, that is to say according to a rotomolding process of the prior art, the bladder of the present invention thus exhibits not only improved leaktightness properties but also a much better surface condition and a greater molecular weight.

The process of the present invention thus makes it possible, entirely unexpectedly and contrary to the numerous abovementioned preconceptions and obstacles encountered with the techniques of the prior art, to manufacture, by rotomolding, bladders composed of polyamide 6 having excellent leaktightness properties.

The PA6 bladder thus formed is neither oxidized nor crosslinked; the polymer has not been subjected to chain cleavages and exhibits neither unmelted material nor residual porosities.

The addition of a nucleating agent, such as talc or sodium benzoate, at a concentration of 0.01 to 1% by weight of the mixture of monomer, of catalyst and of activator, makes it possible to increase the crystallinity of the PA6 obtained.

The addition of a filler, such as clay sheets or carbon black, at a concentration which can range up to 40% by weight of the monomer+catalyst+activator mixture, makes it possible to improve its mechanical properties and/or to reduce the permeation and/or to color and/or to reduce the cost of the bladder obtained.

### Example 3

### Manufacture of a Two-Layer Tank Bladder by a Rotomolding Process in Accordance with the Present Invention

In this example, a liner with a total thickness of 3 mm in two layers, a layer with a thickness of 1.8 mm (external layer) and a layer with a thickness of 1.2 mm (internal layer), was prepared on the basis of the same protocol as that which is described in example 2 above.

The polymerization was an anionic polymerization. The precursor monomer which was used is ε-caprolactam exhibiting the following characteristics:
Supplier: DSM Fibre Intermediate B.V.
Grade: AP-caprolactam
Melting point: 69° C.

Bromomagnesium caprolactam (20%) in caprolactam was used as polymerization catalyst, the characteristics of which are as follows:
Supplier: Brüggemann Chemical
Commercial grade: Bruggolen C1 (registered trade mark)
Form: flakes
Melting point: approximately 70° C.

Acetylhexanelactam was used as activator, the characteristics of which are as follows:
Supplier: Brüggemann Chemical
Commercial grade: Activator 0
Form: liquid
Melting point: −13° C.

The thermoplastic polymer which was obtained is polyamide 6 (or polycaprolactam) exhibiting the following final main properties:
density: 1.15 g/cm³
molar mass: 50-300 kg/mol
melting point: 225° C.
modulus of elasticity: 3.6 GPa (EH 0-23° C.)
yield point stress: 90 MPa (EH 0-23° C.)
deformation at break: 70% (EH 0-23° C.)
hydrogen permeation (4 bar, 27° C.): 3.7×10⁻¹⁷ mol/m·Pa·s.

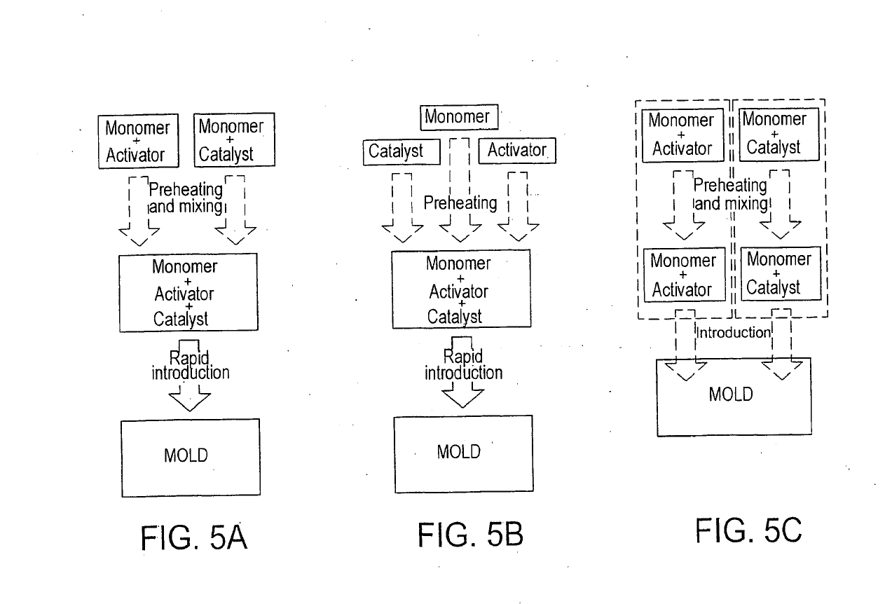

The rotomolding was carried out under dry nitrogen in a rotomolder of Shuttle type from STP Equipment with the reference LAB40. FIG. 4 exhibits the Rotolog (registered trade mark) rotomolding curve of this device: on the abscissa, the time in minutes and, on the ordinate, the temperature in ° C. In this figure, the curve (30) represents the temperature of the oven in ° C. and the curve (32) represents the temperature of the gas inside the mold.

The rotomolding protocol which was employed in this example is as follows:
oven temperature: 220° C.
preheating of the mold to 160° C.
total amount of material: 400 g
for layer 1, mixture of 230 g of AP-caprolactam and of 10 g of catalyst, Bruggolen C1 (registered trade mark): referred to as mixture 1
for layer 2, mixture of 150 g of AP-caprolactam and of 8 g of catalyst, Bruggolen C1 (registered trade mark): referred to as mixture 2
preheating of the two mixtures to 130° C.
introduction of mixture 1 into the mold, followed by 3 g of activator, “Activator 0”
primary rotational speed: 10 rpm
secondary rotational speed: 5.2 rpm
polymerization: 2.30 minutes
halting of the rotation
introduction of mixture 2 into the mold, followed by 2 g of Activator 0
primary rotational speed: 10 rpm
secondary rotational speed: 5.2 rpm
polymerization: 4 minutes
removal from the mold of the bladder obtained.

FIG. 4, with reference to the abscissa, makes it possible to monitor over time the protocol of this example: from 0 to 7 minutes: duration of the preheating of the mold; at 8 minutes: charging the first mixture; at 9 minutes: introduction of the mold into the oven; at 12 minutes: removal of the mold from the oven and charging the second mixture; at 14 minutes: reintroduction of the mold into the oven; and, at 19 minutes: removal of the bladder from the mold.

This protocol has made it possible to manufacture, by rotomolding, two-layer bladders exhibiting the abovementioned properties (see example 2). The two-layer bladder formed is neither oxidized nor crosslinked and the polymer has not been subjected to chain cleavages and exhibits neither unmelted material nor residual porosities.

### Example 4

### Preparation of the Polymerization Mixture

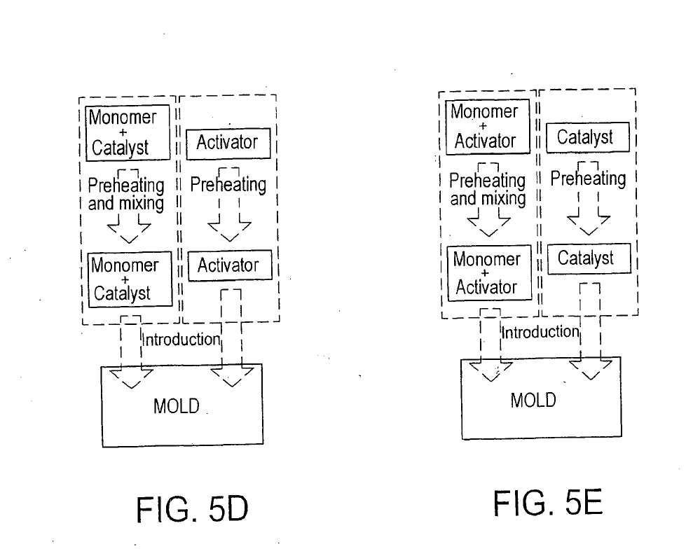

FIGS. 5A to 5E diagrammatically exhibit different methods of preparation of polymerization mixtures for the implementation of the process of the present invention.

The materials and operating conditions are those described in the above implementational examples.

In FIG. 5A, a first mixture containing the monomer and the activator is prepared; a second mixture containing the monomer and the catalyst is prepared; these mixtures are preheated and then mixed together to produce the polymerization mixture, which is then rapidly introduced into the rotomold in order for the polymerization to begin in the latter.

In FIG. 5B, the catalyst, the monomer and the activator are preheated independently and then mixed together to produce the polymerization mixture, which is then rapidly introduced into the rotomold in order for the polymerization to begin in the latter.

In FIG. 5C, a first mixture containing the monomer and the activator is prepared; a second mixture containing the monomer and the catalyst is prepared; these mixtures are preheated separately and then introduced simultaneously into the rotomold, thus forming the polymerization mixture, in order for the polymerization to begin in the latter.

In FIG. 5D, a first mixture containing the monomer and the catalyst is prepared; this first mixture, on the one hand, and the activator, on the other hand, are preheated separately and then the preheated first mixture and the preheated activator are introduced simultaneously into the rotomold, thus forming the polymerization mixture, in order for the polymerization to begin in the latter.

In FIG. 5E, a first mixture containing the monomer and the activator is prepared; this first mixture, on the one hand, and the catalyst, on the other hand, are preheated separately and then the preheated first mixture and the preheated catalyst are introduced simultaneously into the rotomold, thus forming the polymerization mixture, in order for the polymerization to begin in the latter.

Generally, preferably, the polymerization mixture is not prepared in its entirety (monomer+activator+catalyst) before being introduced into the mold, in order for the polymerization not to begin outside the mold. The homogeneity of the bladder obtained is thus better.

### Example 5

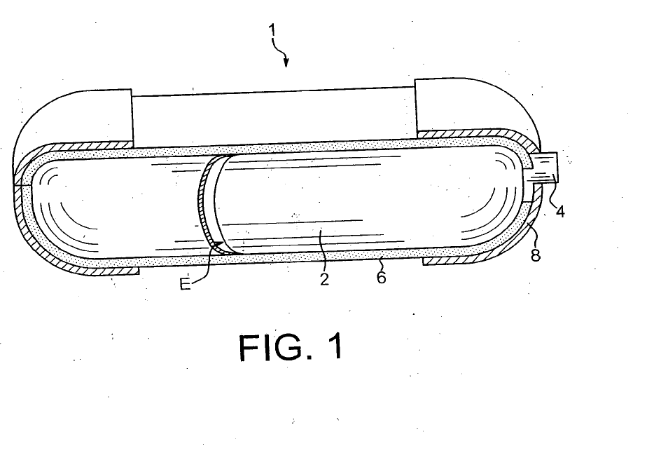

### Manufacture of a Type IV Tank (See FIG. 1)

An aluminum socket (4) (after optionally having been subjected to a treatment as in the document [4]) is positioned in the mold before the reactive rotomolding of the bladder, in the way disclosed in the document [23].

The bladder made of PA6 is formed by reactive rotomolding, by in situ anionic polymerization, in accordance with the process of the present invention. The protocol of example 2 is used in the presence of the socket. The bladder (2) obtained, comprising the socket (4), is removed from the mold. The socket/bladder connection is very close, in contrast to that of a bladder obtained with a protocol for rotomolding by melting the thermoplastic.

The interface between the bladder and the aluminum socket used to manufacture the tank (1) is better than by using the rotomolding protocol of example 1 as the viscosity of the monomer at the beginning of the reaction is very low and the material being polymerized diffuses very readily into the chinks and/or points of attachment of the socket. The joining of the bladder and socket is thus improved. In FIG. 1, the reference (E) indicates a cross section of the bladder which makes it possible to display, in this figure, the thickness of the bladder.

The bladder is subsequently provided with a reinforcing structure (6). For this, carbon fibers, impregnated beforehand with noncrosslinked epoxy resin, are wound around the bladder held by the socket or sockets (the bladder acts as winding tube), according to one of the processes disclosed in the documents [4], [5], [24] or [25], for example.

A protective shell (8) can subsequently be positioned around the filament winding, as represented in cross section in FIG. 1. A valve/regulator can be screwed onto the tank, in the socket (not represented).

A type IV tank is thus obtained. This tank exhibits the leaktightness specifications mentioned in example 2 above.

### Example 6

### Manufacture of a PA6 Multilayer Bladder

For example, it is possible to envisage manufacturing a two-layer bladder with a total thickness of 6 mm, with a first external layer made of PA6 without a specific filler with a thickness of 3 mm and a second internal layer made of PA6 comprising 15% by weight of filler as exfoliated clay sheets for increasing the thermal stability of the bladder (heating during the rapid filling with hydrogen, for example).

The protocol of example 2 above is suitable for manufacturing this type of bladder. It is carried out twice: a first time for the external layer of the bladder, in contact with the rotomold, and with a mixture of polymer, of catalyst and of activator; and a second time for the internal layer, in contact with the external layer, with a mixture of polymer, of catalyst, of activator and a filler composed of 15% by weight of exfoliated clay sheets of montmorillonite treated beforehand with a quaternary dimethyltallowbenzylammonium ion from the supplier Süd Chemie (commercial grade “Nanofil 919”), for the purpose of improving the thermostability of the bladder, in particular to the heating during the rapid filling with hydrogen.

### Example 7

### Posttreatment of a Bladder Obtained According to the Process of the Invention

A bladder manufactured according to the process of the present invention, for example according to the protocol of example 2, can be subjected to a posttreatment, such as those mentioned in the part of the invention set out above, in order to improve its leaktightness properties and its internal and/or external surface chemical properties.

Posttreatment examples applicable to the bladder are disclosed in the documents [26] and [27].

### LIST OF THE REFERENCES

[1] FR-A-2 813 232: Procédé de fabrication d′ une pièce de révolution par rotomoulage et pièce obtenue [Process for the manufacture of a component of revolution by rotomolding and component obtained].
[2] FR-A-2 813 235: Structure et réservoir thermoplastique [Thermoplastic tank and structure].
[3] U.S. Pat. No. 4,927,038: “Container for high pressure gases”.
[4] U.S. Pat. No. 4,925,044: “Fluid tank and method of manufacturing it”.
[5] U.S. Pat. No. 5,499,739: “Thermoplastic liner for and method of overwrapping high pressure vessels”.
[6] U.S. Pat. No. 6,554,939: “Container and method of forming the container”.
[7] U.S. Pat. No. 5,568,878: “Filament wound pressure vessel having a reinforced access opening”.
[8] U.S. Pat. No. 6,660,214: “Pressure vessel manufacture method”.
[9] http://www.rotomoulage.org
[10] “Next Generation Hydrogen Tankage”, Laurence Livermore National Laboratory, Proceedings of the 2001 U.S. DOE Hydrogen Program Review.
[11] “Hydrogen Composite Tank Program”, Quantum Technologies, Proceedings of the 2002 U.S. DOE Hydrogen Program Review.
[12] “Hydrogen Composite Tank Project”, Quantum Fuel System Technologies, FY 2003, Progress Report.
[13] “Development of a Compressed Hydrogen Gas Integrated Storage System (CH₂-ISS) for Fuel Cell Vehicles”, University Applied Physics Laboratory, FY 2003 Progress Report.
[14] “Next Generation Hydrogen Storage”, Laurence Livermore National Laboratory, FY 2003 Progress Report.
[15] “Low Permeation Liner for Hydrogen Gas Storage Tanks”, Idaho National Engineering & Environmental Laboratory, FY 2003 Progress Report.
[16] U.S. Pat. No. 3,275,733: “Process for the production of hollow articles of polymerized lactams”.
[17] “Anionic Polymerization, Principles and Practical Applications”, Henry L. Hsieh and Roderick P. Quirck, 1996, Publisher: Marcel Dekker Inc., New York
[18] Review “Oil & Gas Science and Technology”, Revue de l'Institut Français du Pétrole, special issue 2001, May-June, vol. 56, No. 3, pp. 215-312, Editions Technip, 27, rue Ginoux, 75737 Paris Cedex 15
[19] Book, “Introduction des Coques Minces [Introduction to Thin Shells]”, Patrick Muller, Claire Ossadzow, Hermes Science Publications, Paris, 1999. Hermes Science Publications, 8 quai du Marché-Neuf, 75004 Paris, France
[20] Book, “Formulaire Technique [Engineering Formulas]”, Kurt Gieck, 10th Edition, September, 1997, Dunod.
[21] “Etude de la nature de couches barrières à l'oxygène réalisées par plasma basse fréquence en fonction des conditions d'élaboration [Study on the nature of barrier layers to oxygen produced by low frequency plasma as a function of the preparation conditions]”, Eric Bouvier, Université Paul Sabatier de Toulouse, defended on Sep. 14, 1999, order number 3457.
[22] “Trends in Barrier Design”, May 1991, Journal of Packaging, Japan
[23] U.S. Pat. No. 5,538,680: “Method of molding a polar boss to a composite pressure vessel”.
[24] U.S. Pat. No. 6,171,423: “Method for fabricating composite pressure vessels”.
[25] U.S. Pat. No. 5,577,630: “Composite conformable pressure vessel”.
[26] U.S. Pat. No. 6,328,805: “Equipment for processing using a low-pressure plasma having an improved vacuum circuit”.
[27] U.S. Pat. No. 5,902,643: “Multilayer packaging material having aminoepoxy gas barrier coating”.

What is claimed is:

1. A process for the manufacture of a type IV composite tank comprising, in this order, from the inside of the tank outwards:
a bladder for leaktightness to the pressurized gas composed of a thermoplastic polymer,
at least one metal socket which provides the interior/exterior connection of the tank for the filling thereof and for the use of the stored gas, and
a member for mechanically reinforcing the bladder;
said process comprising the following stages:
(a) preparation of a polymerization mixture comprising the precursor monomer of the thermoplastic polymer, a polymerization catalyst and a polymerization activator;
(a′) positioning of said at least one metal socket of the tank in a mold intended to mold the leaktight bladder of the tank,
(b) polymerization of said mixture to give said thermoplastic polymer in said mold set rotating at a working temperature greater than or equal to the melting point of said monomer and lower than the melting point of said polymer, so as to form said bladder by polymerization of said monomer coupled to rotomolding and without melting of the thermoplastic polymer obtained;
(b1) optional repetition of stages (a) of preparation of a polymerization mixture and (b) of polymerization of the mixture in the mold, so as to obtain a bladder comprising several layers of thermoplastic polymer;
(c) removal from the mold of the thermoplastic polymer bladder obtained provided with said at least one socket; and
(d) deploying the member for mechanically reinforcing the bladder which provides the tank with mechanical strength.

2. The process as claimed in claim 1, in which, in stage (a), the polymerization mixture is furthermore preheated, so as to melt the monomer, to a preheating temperature greater than or equal to the melting point of said monomer and lower than the melting point of said polymer.

3. The process as claimed in claim 1, in which the mold is purged by a dry inert gas for the implementation of the polymerization stage (b).

4. The process as claimed in claim 1, in which the mold is set rotating along two axes, so that the polymerization takes place over the entire internal surface of the mold and in accordance with the internal surface and over the metal socket positioned in the mold.

5. The process as claimed in claim 1, in which the activator is a first substituted ε-caprolactam.

6. The process as claimed in claim 5, in which the catalyst is a second substituted ε-caprolactam.

7. The process as claimed in claim 1, in which the polymerization mixture furthermore comprises a nucleating agent and/or fillers and/or nanofillers.

8. The process as claimed in claim 1, in which the thermoplastic polymer is a polycaprolactam and the monomer its precursor, the polymerization of the monomer being an anionic polymerization.

9. The process as claimed in claim 1, in which the thermoplastic polymer is a polycaprolactam and the monomer is a caprolactam or an ε-caprolactam or a mixture of these, the polymerization of the monomer being an anionic polymerization.

10. The process as claimed in claim 9, in which the thermoplastic polymer is a polycaprolactam and in which the stage consisting in polymerizing the precursor monomer of the polycaprolactam to give said polycaprolactam in the rotating mold is carried out at a working temperature of 100 to 180° C.

11. The process as claimed in claim 1, in which the deploying of the member for mechanically reinforcing is carried out by means of a filament winding around the bladder, which acts as winding tube for this winding, said filament winding being composed of carbon fibers and of thermosetting resin.

12. The process as claimed in claim 1, in which said leaktight bladder is a polyamide bladder, said at least one metal socket is an aluminum socket and said external member for mechanically reinforcing is a filament winding composed of carbon fibers and of thermosetting resin.
